(19) United States
(12) Patent Application Publication
(10) Pub. No.: US 2004/0173271 A1
(43) Pub. Date: Sep. 9, 2004

(54) Quick connect chemical injector

(76) Inventor: Stephen Keith Nance, Jackson, TN (US)

Correspondence Address: SUITER WEST PC LLO, 14301 FNB PARKWAY, SUITE 220, OMAHA, NE, 68154, US

(21) Appl. No.: 10/377,925

(22) Filed: Mar. 3, 2003

(51) Int. Cl. F17D 1/00

(52) U.S. Cl. 137/895

(57) ABSTRACT

An external fluid injector assembly comprises a housing with a main fluid passage running through the housing. The housing includes a port enabled to couple the housing with a fluid pump (e.g., hydraulic pump or pneumatic pump) to receive a pressurized fluid stream into the main fluid passage. On the opposite end of the housing is a coupling assembly which allows an operator to attach a variety of devices, such as a hose. An injector assembly is connected to the housing and is capable of providing an external fluid to the pressurized fluid stream in the main fluid passage.

### FIELD OF THE INVENTION

The present invention generally relates to the field of pressurized systems, and particularly to an external fluid injector for use with hydraulic systems, such as pressure washers.

### BACKGROUND OF THE INVENTION

From cleaning devices to heavy lifting machinery, pressurized hydraulic systems are used to accomplish a variety of tasks. When working with hydraulic systems it is often necessary to provide a connection between the hydraulic pump and a device which will be used to direct the flow of the fluid, such as a hose. Further, it is often desirous to have the ability to add a second or external fluid to the pressurized fluid stream being forced from the hydraulic pump. However, many of the systems available to add an external fluid to the pressurized fluid stream being forced from the hydraulic pump are only available as multiple piece assemblies.

For example, a conventional injector assembly may include a first housing disposed with a port which may allow the housing to couple with a fluid pump. The first housing may further include an external fluid connection assembly and a first connector assembly. The first connector assembly may be capable of connecting with a second housing. The second housing may be disposed with a female quick connect assembly which is capable of connecting with a fluid transfer device (i.e., a hose). The connection of the first and second housings allows the pressurized fluid to flow from the fluid pump to the hose and is enabled to add an external fluid to the pressurized fluid stream.

Unfortunately, these multiple piece assemblies being employed are often burdensome on the manufacturer and the operator. For the manufacturer, increased material and tooling costs are incurred to produce these multiple piece assemblies. For the operator, time is lost assembling the device for attachment to the hydraulic pump and increased costs are realized from the increased costs of production. Reducing costs to the manufacturer and the consumer and increasing the ease of use of these devices would provide a substantial benefit.

Therefore, it would be desirable to provide a single piece assembly which would allow for the transfer of a pressurized fluid stream between a pump and a fluid transfer device (i.e., a hose) and also allow for the addition of an external fluid to the pressurized fluid stream.

### SUMMARY OF THE INVENTION

Accordingly, the present invention is directed to an external fluid injector assembly which allows for the addition of an external fluid to the pressurized fluid being forced from a hydraulic pump. In a first aspect of the present invention, an external fluid injector assembly comprises a housing including a main fluid passage running through the housing and a port which enables the coupling of the main fluid passage with a fluid pump. On the opposite end of the housing a coupling assembly is disposed which allows an operator to attach a variety of fluid transfer assemblies, such as a hose. An injector assembly is connected to the housing and provides a coupling to the main fluid passage. The injector assembly is capable of providing an external fluid to the main fluid passage. Thus, the external fluid injector assembly provides, in a single piece assembly, the ability to add an external fluid to a pressurized fluid stream from the fluid pump and connect a hose, or other similar devices.

In a second aspect of the present invention, an external chemical injector assembly comprises a housing including a main fluid passage running through the housing and a port which enables the coupling of the main fluid passage with a fluid pump. On the opposite end of the housing a coupling assembly is disposed which allows an operator to attach a variety of fluid transfer assemblies, such as a hose. An injector assembly is connected to the housing and provides a coupling to the main fluid passage. The injector assembly is capable of providing an external fluid to the main fluid passage. A stop valve assembly is coupled with the injector assembly to prevent the external fluid from entering the main fluid passage. Thus, the external fluid injector assembly provides, in a single piece assembly, the ability to add or prevent the addition of an external fluid to a pressurized fluid stream from the fluid pump and connect a hose, or other similar devices.

In a third aspect of the present invention, an apparatus comprising a fluid pump assembly coupled with an external chemical injector assembly provides a pressurized fluid stream to which a chemical may be added. An external chemical injector assembly comprises a housing including a main fluid passage running through the housing and a port which enables the coupling of the main fluid passage with a fluid pump. On the opposite end of the housing a coupling assembly is disposed which allows an operator to attach a variety of chemical transfer assemblies, such as a hose. An injector assembly is connected to the housing and provides a coupling to the main fluid passage. The injector assembly is capable of providing a chemical to the main fluid passage. Thus, the external fluid injector assembly provides, in a single piece assembly, the ability to add or prevent the addition of an external fluid to a pressurized fluid stream from the fluid pump and connect a hose, or other similar devices.

In a fourth aspect of the present invention, an apparatus comprising a pressure washer assembly coupled with an external chemical injector assembly provides a pressurized fluid stream to which a chemical may be added. An external chemical injector assembly comprises a housing including a main fluid passage running through the housing and a port which enables the coupling of the main fluid passage with a fluid pump. On the opposite end of the housing a coupling assembly is disposed which allows an operator to attach a variety of chemical transfer assemblies, such as a hose. An injector assembly is connected to the housing and provides a coupling to the main fluid passage. The injector assembly is capable of providing a chemical to the main fluid passage. Thus, the external fluid injector assembly provides, in a single piece assembly, the ability to add or prevent the addition of an external fluid to a pressurized fluid stream from the fluid pump and connect a hose, or other similar devices.

It is to be understood that both the forgoing general description and the following detailed description are exemplary and explanatory only and are not restrictive of the invention as claimed. The accompanying drawings, which are incorporated in and constitute a part of the specification, illustrate an embodiment of the invention and together with the general description, serve to explain the principles of the invention.

### BRIEF DESCRIPTION OF THE DRAWINGS

The numerous advantages of the present invention may be better understood by those skilled in the art by reference to the accompanying figures in which:

FIG. 1 is an illustration of an external fluid injector assembly in accordance with an exemplary embodiment of the present invention;

FIG. 2 is an illustration of a pressure washer system including the external fluid injector assembly in accordance with an exemplary embodiment of the present invention;

FIG. 3 is an illustration of a portable pressure washer system including the external fluid injector assembly in accordance with an exemplary embodiment of the present invention; and

FIG. 4 is an illustration of an external fluid injector assembly including a stop valve in accordance with an exemplary embodiment of the present invention.

### DETAILED DESCRIPTION OF THE INVENTION

Reference will now be made in detail to the presently preferred embodiments of the invention, examples of which are illustrated in the accompanying drawings.

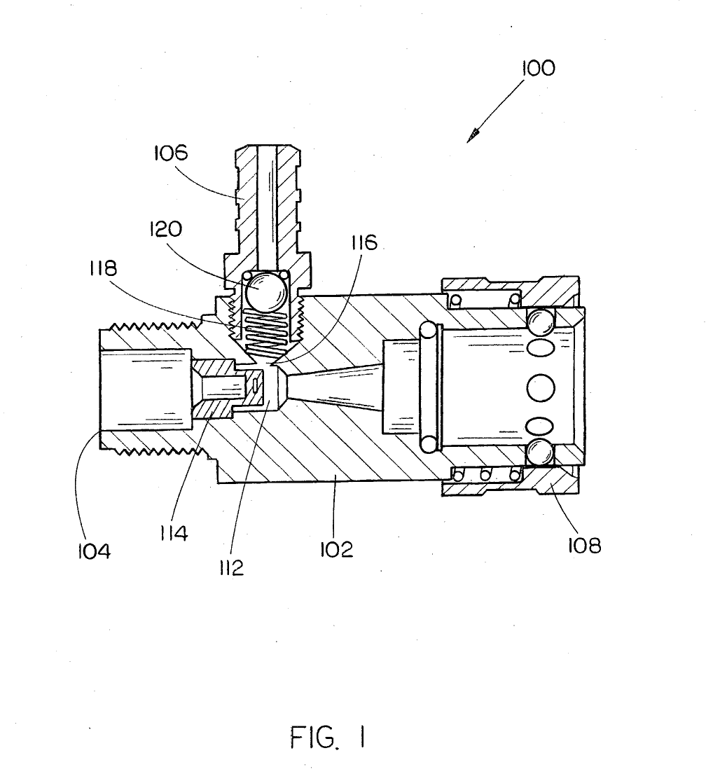

Referring generally now to FIGS. 1 through 4, exemplary embodiments of the present invention are shown. In a preferred embodiment, an external fluid injector assembly 100 is shown in FIG. 1. The external fluid injector assembly 100 includes a housing 102 disposed with a port 104. The port 104, enables the housing 102 to operably couple with a fluid pump, such as a hydraulic pump or pneumatic pump (e.g., vacuum pump). Thus, the housing 102 may receive, through the port 104, a pressurized fluid stream from the fluid pump. The housing is coupled with an injector assembly 106, and a coupling assembly 108. Preferably, the coupling assembly 108 comprises a female quick connect assembly allowing it to couple to a male quick connect fitting.

The housing 102 is disposed with a main fluid passage 112. The main fluid passage 112 includes an orifice 114. The injector assembly 106 couples through an inlet port 116, downstream of the orifice 114, with the main fluid passage 112. Disposed proximally to the inlet port 116 is a compression spring 118 which in operation with a steel ball 110 comprise a spring loaded check valve disposed within the central passage of the injector assembly 106.

The main fluid passage 112 runs through the coupling assembly 108. Thus, when a hose or other suitable device is connected, via the female quick connect assembly, to the coupling assembly 108 of the external fluid injector assembly 100, the pressurized fluid stream from the fluid pump, that entered through the port 104 disposed on the housing 102, is passed on to the hose. The female quick connect assembly may be a variety of connecting assemblies that meet standardized or non-standardized connection criteria as set forth by the International Organization for Standardization (ISO). The coupling assembly may comprise a threaded fitting, a compression assembly, lock assembly, and the like. Thus, the single piece external fluid injector assembly 100, of the present invention, may employ a variety of connection assemblies for the attachment of a fluid transfer device as may be contemplated by one of ordinary skill in the art. Further, it is understood that the housing 102 may comprise a threaded port assembly, a quick connect assembly, compression assembly, lock assembly, and the like, in order to couple with the fluid pump.

The injector assembly 106 provides an inlet for an external fluid into the main fluid passage. Therefore, the external fluid enters the pressurized fluid stream through the inlet port 116 down stream from the orifice 114. The flow of pressurized fluid through the main fluid passage 112 and the orifice 114 creates a pressure drop resulting in a vacuum pressure inside the inlet port 116. The spring loaded check valve, including the compression spring 118 and the steel ball 110, allow the external fluid into the pressurized fluid stream. The amount of external fluid that is allowed to enter the pressurized fluid stream varies with the vacuum pressure within the orifice 114. As the vacuum pressure overcomes the spring loaded check valve, the external fluid flows into the main fluid passage 112. The greater or lesser the vacuum pressure translates into a greater or lesser amount of external fluid being allowed into the pressurized fluid stream running through the main fluid passage 112. For instance, as the vacuum pressure reduces, the spring loaded check valve closes and prevents external fluid from leaking out of the inlet port 116 into the main fluid passage 112.

It is understood that the flow through rate, or the rate at which the pressurized fluid stream flows form the hydraulic pump through the external fluid injector assembly 100 into the fluid transfer device (i.e., a hose), of present invention is scalable. For example, by increasing the size of the orifice 114, the present invention effectively decreases the siphon rate (rate that external fluid is metered into the main fluid passage 112) and increases the flow through rate. The tension of the compression spring 118 may be increased or decreased to affect the amount of external fluid allowed to enter the main fluid passage. For instance, by increasing the tension, the compression spring 118 resists being compressed and requires a higher vacuum pressure in order to draw the external fluid into the main fluid passage 112. Further, the size of the passage connecting the inlet port 116 with the main fluid passage 112 may be varied to affect the amount of external fluid allowed into the main fluid passage.

The external fluid injector assembly 100, may alternatively be employed with a pneumatic system. Thus, the external fluid to be added to the pressurized air stream provided by a pneumatic pump may be a variety of gaseous compounds, such as hydrogen gas, helium gas, chlorine gas, and the like.

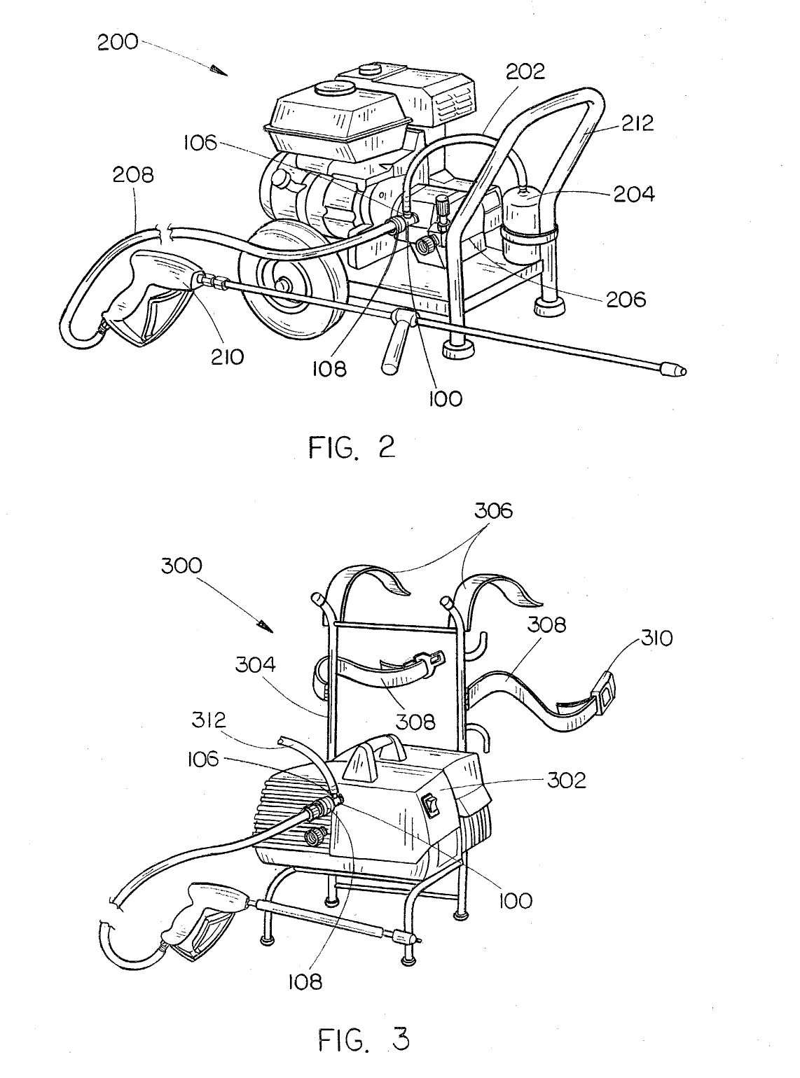

A pressure washer system 200 including the external fluid injector assembly 100, is shown in FIG. 2. In the current embodiment the injector assembly 106 is shown coupled with a first hose 202. The first hose 202 is also coupled with a container 204. The container 204 stores a cleaning chemical solution in liquid form. Thus, the external fluid injector assembly 100 becomes a chemical injector assembly. The external fluid injector assembly is coupled to a hydraulic pump 206 through the port 104. The hydraulic pump provides a pressurized stream of water to the external fluid injector assembly 100.

The external fluid injector assembly 100 is further coupled with a second hose 208. The second hose 208 couples with the female quick connect assembly disposed on the coupling assembly 108. The second hose 208 is coupled with a nozzle assembly 210 which sprays the pressurized fluid stream. In this manner, the external fluid injector assembly 100, of the present invention, provides a single piece assembly capable of providing external fluid injection into a pressurized water stream. In FIG. 2 the hydraulic pump 206 is coupled to a mounting assembly 212. The mounting assembly 212 includes wheels to provide transportability. It is understood that the mounting assembly to which the hydraulic pump 202, including the external fluid injector assembly 100, is attached may vary as contemplated by one of ordinary skill in the art. For example, a portable pressure washer system 300 is shown in FIG. 3. The portable pressure washer system 300 includes a hydraulic pump 302 coupled with the external fluid injector assembly 100. The portable pressure washer system 300 further includes a mounting assembly 304 coupled with the hydraulic pump 302. The mounting assembly 304 includes a shoulder harness assembly 306 and a belt assembly 308 including a buckle assembly 310. The shoulder harness assembly 306 is suitable for engaging an operator's shoulders while the belt assembly 308 straps around the operator and fastens in place. In this manner the operator may use the present invention as a back-pack of sorts and be enabled to provide pressure washing in a variety of locations.

The portable pressure washer system 300 also includes a first hose 312 coupled with the injector assembly 106. The first hose 312 is capable of connecting with a variety of assemblies. These assemblies may contain a variety of liquid solutions which may be added to the pressurized fluid stream provided to the external fluid injector assembly 100 from the hydraulic pump 302. A second hose 314 couples with the female quick connect assembly disposed on the coupling assembly 108. The second hose 314 is also coupled with a nozzle assembly 316 which sprays the pressurized fluid stream.

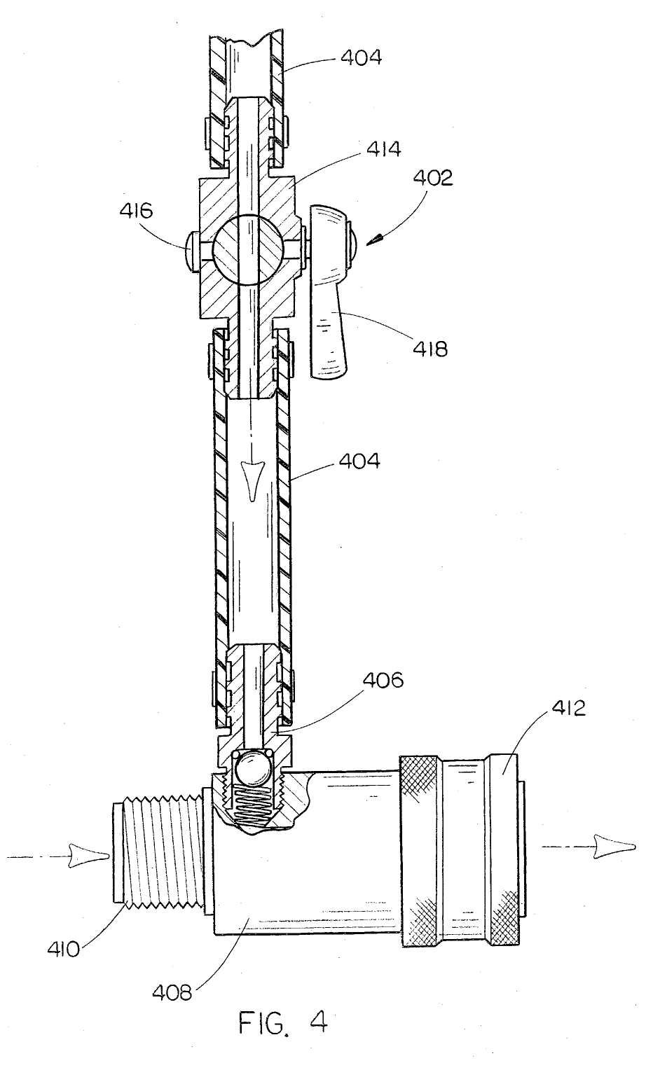

Referring now to FIG. 4, an external fluid injector assembly 400 including a stop valve assembly 402, is shown. In the preferred embodiment the stop valve assembly 402 includes a housing 414 which is coupled with a hose 404. The stop valve assembly 402 further includes a clamp 416 coupled with a rotating fastener 418 to activate the clamp 416. The hose 404 couples with the injector assembly 406. The injector assembly 406 is coupled with a housing 408 including a threaded port 410 and a quick connect assembly 412. It is contemplated that the stop valve assembly 402 may be coupled directly with the injector assembly 406 and the hose 404 may only couple with the stop valve assembly 402. A variety of assemblies may be employed to provide a way to prevent the external fluid from entering the injector assembly and/or main fluid passage without departing from the scope and spirit of the present invention.

It is believed that the quick connect chemical injector of the present invention and many of its attendant advantages will be understood by the forgoing description. It is also believed that it will be apparent that various changes may be made in the form, construction and arrangement of the components thereof without departing from the scope and spirit of the invention or without sacrificing all of its material advantages. The form herein before described being merely an explanatory embodiment thereof. It is the intention of the following claims to encompass and include such changes.

What is claimed is:

1. An external fluid injector assembly, comprising:
a housing including a main fluid passage, the housing further including a port suitable for connecting the main fluid passage with a fluid pump;
an injector assembly, including a central passage disposed with a check valve, coupled with the housing, the injector assembly being suitable for providing an external fluid into the main fluid passage; and
a coupling assembly coupled with the housing, the coupling assembly being suitable for coupling an external fluid transfer assembly to the housing,
wherein the external fluid injector assembly is a single piece assembly.

2. The external fluid injector assembly of claim 1, wherein the check valve is a spring loaded check valve.

3. The external fluid injector assembly of claim 1, wherein the coupling assembly is at least one of a female quick connect fitting, a threaded fitting, and a locking assembly.

4. The external fluid injector assembly of claim 1, further comprising a second injector assembly.

5. The external fluid injector assembly of claim 1, wherein the housing connects to the fluid pump via at least one of a threaded port assembly, a quick connect assembly, a compression assembly, and a locking assembly.

6. An external chemical injector assembly, comprising:
a housing including a main fluid passage, the housing further including a port suitable for connecting the main fluid passage with a fluid pump;
an injector assembly, including a central passage disposed with a check valve, coupled with the housing, the injector assembly being suitable for providing an external fluid into the main fluid passage;
a stop valve assembly coupled with the injector assembly, the stop valve assembly being suitable for preventing the external fluid from entering the main fluid passage; and
a coupling assembly coupled with the housing, the coupling assembly being suitable for coupling an external fluid transfer assembly to the housing,
wherein the external fluid injector assembly is a single piece assembly.

7. The external chemical injector assembly of claim 6, wherein the check valve is a spring loaded check valve.

8. The external chemical injector assembly of claim 6, wherein the coupling assembly is at least one of a female quick connect fitting, a threaded fitting, and a locking assembly.

9. The external chemical injector assembly of claim 6, further comprising a second injector assembly.

10. The external chemical injector assembly of claim 6, wherein the housing connects to the fluid pump via at least one of a threaded port assembly, a quick connect assembly, a compression assembly, and a locking assembly.

11. An apparatus, comprising:
a fluid pump assembly for providing a pressurized stream of fluid; and
an external chemical injector assembly coupled with the fluid pump assembly, the external chemical injector assembly being suitable for receiving the pressurized stream of fluid and providing a chemical to the pressurized stream of fluid,
wherein the external chemical injector assembly is a single piece assembly.

12. The apparatus of claim 11, wherein the external chemical injector assembly further comprises:
a housing including a main fluid passage, the housing further including a port suitable for connecting the main fluid passage with the fluid pump assembly;
an injector assembly, including a central passage disposed with a check valve, coupled with the housing, the injector assembly being suitable for providing the chemical into the main fluid passage; and
a coupling assembly coupled with the housing, the coupling assembly being suitable for coupling a chemical transfer assembly to the housing.

13. The external chemical injector assembly of claim 12, wherein the check valve is a spring loaded check valve.

14. The external chemical injector assembly of claim 12, wherein the coupling assembly is at least one of a female quick connect fitting, a threaded fitting, and a locking assembly.

15. The external chemical injector assembly of claim 12, wherein the external chemical injector assembly is disposed with a second injector assembly.

16. The external chemical injector assembly of claim 12, wherein the external chemical injector assembly further comprises a stop valve assembly for preventing the external fluid from entering the main fluid passage while fluid passes through the main fluid passage.

17. The external chemical injector assembly of claim 12, wherein the housing connects to the fluid pump assembly via at least one of a threaded port assembly, a quick connect assembly, a compression assembly, and a locking assembly.

18. An apparatus, comprising:
a pressure washer assembly, including a fluid pump for providing a pressurized stream of fluid; and
an external chemical injector assembly coupled with the fluid pump, the external chemical injector assembly being suitable for receiving the pressurized stream of fluid and providing a chemical to the pressurized stream of fluid,
wherein the external chemical injector assembly is a single piece assembly.

19. The apparatus of claim 18, wherein the external chemical injector assembly further comprises:
a housing including a main fluid passage, the housing further including a port suitable for connecting the main fluid passage with a fluid pump;
an injector assembly, including a central passage disposed with a check valve, coupled with the housing, the injector assembly being suitable for providing the chemical into the main fluid passage; and
a coupling assembly coupled with the housing, the coupling assembly being suitable for coupling a chemical transfer assembly to the housing.

20. The external chemical injector assembly of claim 19, wherein the check valve is a spring loaded check valve.

21. The external chemical injector assembly of claim 19, wherein the coupling assembly is at least one of a female quick connect fitting, a threaded fitting, and a locking assembly.

22. The external chemical injector assembly of claim 19, wherein the external chemical injector assembly is disposed with a second injector assembly.

23. The external chemical injector assembly of claim 19, wherein the external chemical injector assembly further comprises a stop valve assembly for preventing the external fluid from entering the main fluid passage while fluid passes through the main fluid passage.

24. The external chemical injector assembly of claim 19, wherein the housing connects to the fluid pump via at least one of a threaded port assembly, a quick connect assembly, a compression assembly, and a locking assembly.
